(19) United States
(12) Patent Application Publication
(10) Pub. No.: US 2004/0033059 A1
(43) Pub. Date: Feb. 19, 2004

(54) Image recording/reproducing apparatus having enhanced ability to recover motion picture data in the event of recording error

(76) Inventors: Chul-Min Kim, Suwon-city (KR); Yun-Ju Kang, Suwon-city (KR)

Correspondence Address: ROYLANCE, ABRAMS, BERDO & GOODMAN, L.L.P., 1300 19TH STREET, N.W., SUITE 600, WASHINGTON,, DC, 20036, US

(21) Appl. No.: 10/636,634

(22) Filed: Aug. 8, 2003

(30) Foreign Application Priority Data
Aug. 17, 2002 (KR) 2002-48727

(51) Int. Cl. H04N 5/781

(52) U.S. Cl. 386/113; 386/125

(57) ABSTRACT

An image recording/reproducing apparatus includes a first device for reproducing motion picture data from a recording medium, a second device for recording the data in a data recording region, and recording additional information containing a recording location information of the motion picture data and backup data for the additional information in a user recording region. The apparatus further includes, an abnormal operation detecting unit for determining whether an error occurs in the recording of the second device while the motion picture data is being recorded in the data recording region, a reset unit for re-driving the first and the second devices, when an error occurs, and a control unit for determining an error occurring location of the motion picture data recorded in the data recording region based on the additional information recorded in the user recording region of the re-driven second device. In the event of error occurrence during a recording of the motion picture data, the motion picture data that contains no error can be safely recovered.

### CROSS REFERENCE TO RELATED APPLICATIONS

This application claims benefit under 35 U.S.C. § 119 from Korean Patent Application No. 2002-48727, filed on Aug. 17, 2002, the entire content of which is incorporated herein by reference.

### BACKGROUND OF THE INVENTION

1. Field of the Invention

The present invention relates generally to an image recording/reproducing apparatus, and more particularly, to an image recording/reproducing apparatus comprising a first and second device having independent functions and located within one casing. Furthermore the invention pertains to a method and apparatus capable of stably recovering motion picture data in the event of error occurrence during the recording of motion picture data from the first device onto the second device.

2. Description of the Related Art

Image recording/reproducing devices, which are capable of recording broadcast signals on a recording medium and reproducing the recorded signals, have been provided with a plurality of functions, as the technology of broadcasting digitized and compressed signals developed. Recently, the image recording/reproducing devices are being provided with a hard disc driver configured as a large-scale memory. Studies are also underway to support the use of various image sources such as satellite and cable broadcasting signals, network broadcasting via the Internet, and the like.

Meanwhile, a combination image recording/reproducing device has been developed having a first and second device in one casing with independent functions. The combination image recording/reproducing device is provided with the capability of reproducing A/V signals. For convenience in describing the present invention, the combination type of image recording/reproducing device having the first and second devices contained in one casing will be referred to as an image recording/reproducing device.

FIG. 1 is a block diagram schematically illustrating a DVD/HDD image recording/reproducing apparatus having a DVD-ROM and a hard disc drive (HDD) in one casing.

Referring to FIG. 1, the DVD/HDD image recording/reproducing apparatus 10 includes a combination of a DVD-ROM 12 and a hard disc drive HDD 14 in one casing. The DVD-ROM 12 reproduces data stored on the recording medium, and the HDD 14 records and reproduces data. While the DVD-ROM 12 and the HDD 14 function independently, they also communicate via an interface which is capable of transmitting and receiving data of both DVD-ROM 12 and HDD 14. Generally, the DVD-ROM 12 reproduces data from optical disc recording mediums such as digital video disks (DVDs), audio compact disks (CDs), video CD and MP3 CD. MP3 is a well known encoding/decoding mechanism, popular in the music industry because of its excellent sound reproduction quality, the small size of its components, among other features.

The DVD/HDD image recording/reproducing apparatus 10 can receive external broadcasting signals, and record the received data on the HDD 14 and output the recorded data externally. Further, the DVD/HDD image recording/reproducing apparatus 10 can output to external devices data received from externally-received broadcasting signals, data reproduced from the DVD-ROM 12, and data reproduced from the HDD 14. The DVD/HDD image recording/reproducing apparatus 10 outputs the broadcasting signals and data to corresponding devices such as audio amp 15, TV 17 and camcorder 19 in accordance with the characteristics of the particular output. Further, the DVD/HDD image recording/reproducing apparatus 10 can record on the HDD 14 the data reproduced from the audio amp 15, the TV 17 and the camcorder 19.

Meanwhile, the DVD/HDD image recording/reproducing apparatus 10 is additionally provided with a feature for recording externally-inputted data on the HDD 14, in addition to the data reproduced from the DVD-ROM 12.

In the event that errors occur during recording on the HDD 14 of the DVD/HDD image recording/reproducing apparatus 10, the HDD 14 removes all the error-containing data from the data recorded in the HDD 14. Accordingly, when an error occurs during the recording of the HDD 14, all the data being recorded is lost. Accordingly, in order to re-record the lost data in the HDD 14, the HDD 14 of the DVD/HDD image recording/reproducing apparatus 10 is required to receive all the data again from the beginning.

Further, when an error occurs, the user has to remove the error and then re-start the DVD/HDD image recording/reproducing apparatus 10 in order to set the initial settings. Then in order to re-record the lost data, the user has to manipulate the DVD/HDD image recording/reproducing apparatus 10 so that the data can be re-input to the HDD 14.

### SUMMARY OF THE INVENTION

An object of the present invention is to substantially solve at least the above problems and/or disadvantages and to provide at least the advantages described below.

Accordingly, it is an object of the present invention to provide a method for recovering motion picture data in the event of a recording error, the method comprising the steps of reproducing image date stored in a first storage device (DVD-ROM), recording image data, additional information and back-up data in a second storage device (HDD), determining that the image data contains an error as it is stored on the second storage device, and recovering error free image data from the additional information and the backup data that corresponds to the image data containing the error.

It is a further object of the invention to provide an image recording/reproducing apparatus for recovering image data in the event of a recording error, the apparatus comprising a first storage device for reproducing image data from a recording medium, a second storage device for recording the image data in a data recording region, and recording additional information containing a recording location information of the image data and backup data for the additional information in a user recording region. The image recording/reproducing apparatus further comprises an abnormal operation detecting unit for determining whether an error occurs in the recording of the image data is being recorded in the data recording region of the second device, a reset unit for re-driving the first and the second devices, when an error occurs, and a control unit for determining an error occurring location of the image data recorded in the data recording region based on the additional information recorded in the user recording region of the re-driven second device and for recovering error free image data from the additional information and the back-up data that corresponds to the image data containing the error.

### BRIEF DESCRIPTION OF THE DRAWINGS

The above objects and other features of the present invention will become more apparent by describing in detail an embodiment thereof with reference to the attached drawings, in which:

FIG. 1 is a block diagram schematically showing a DVD/HDD image recording/reproducing apparatus having a DVD-ROM and a hard disc drive in one casing;

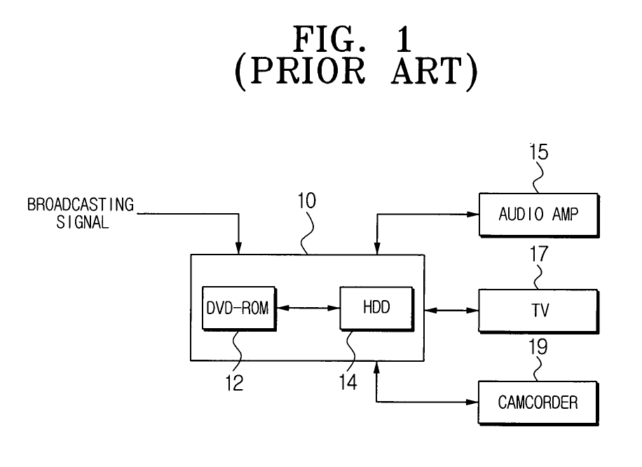

FIG. 2 is a block diagram showing a DVD/HDD image recording/reproducing apparatus capable of recovering recorded data according to an embodiment of the present invention, in the event of an error occurrence during data recording;

FIG. 3 is a view showing recording divided regions from a recording space of the hard disc drive of FIG. 2;

FIG. 4 is a view showing additional information of motion picture data being recorded in a user-record region of FIG. 3; and

FIG. 5 is a flowchart showing a method for recovering the image data in the event of abnormal operation of the DVD/HDD image recording/reproducing apparatus according to an embodiment of the present invention.

### DETAILED DESCRIPTION OF THE PREFERRED EMBODIMENT

Hereinafter, certain embodiments of the present invention will be described in detail with reference to the accompanying drawings.

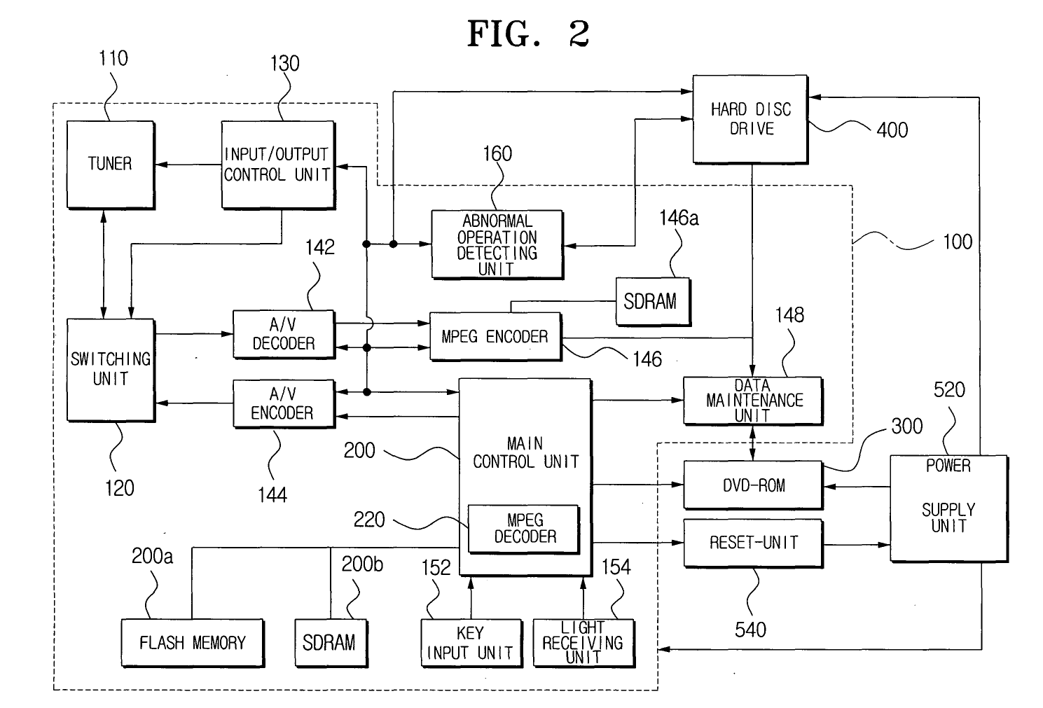

FIG. 2 is a block diagram showing a DVD/HDD image recording/reproducing apparatus capable of recovering recorded data according to an embodiment of the present invention, in the event of an error occurrence during data recording.

Referring to FIG. 2, the DVD/HDD image recording/reproducing apparatus includes signal processing unit 100 a DVD-ROM 300, a hard disc drive (HDD) 400, a main control unit 200, a power supply unit 520 and a reset unit 540.

The DVD-ROM 300 reproduces data from respective optical disc recording mediums such as DVD, audio CD, video CD and MP3 CD. Further, the DVD-ROM 300 may record externally-inputted data onto the optical disc recording mediums.

The HDD 400 records the externally-inputted data and reproduces the recorded data.

Under the control of the main control unit 200, the signal processing unit 100 controls the operations related to the data recording and reproducing of the DVD-ROM 300 and the HDD 400, and encodes and decodes the externally-received data.

The power supply unit 520 converts the externally-fed power to voltages of predetermined levels and supplies the voltages to corresponding parts such as the DVD-ROM 300, the HDD 400 and the signal processing unit 100 for operation thereof.

The reset unit 540 receives from the main control unit 200 a reset command for re-starting the DVD/HDD image recording/reproducing apparatus, and controls the power supply unit 520 to cut off the power supply and then re-supply the power.

The DVD/HDD image recording/reproducing apparatus according to an embodiment of the present invention is constructed to receive at least one kind of image signal from the various image sources. The image sources can be terrestrial television broadcasting, satellite broadcasting, cable lines, computer lines or model lines that can transmit signals. In other words, the DVD/HDD image recording/reproducing apparatus can be constructed to receive at least one kind of signal, from either cable, satellite dish, local cable, a digital broadcast source (DBS), general antenna, Internet, other computer sources, camcorder, disc player, or set-top box.

Meanwhile, the signal processing unit 100 includes a tuner 110, a switching unit 120, an A/V decoder 142, an A/V encoder 144, a MPEG encoder 146, a data maintenance unit 148 and a main control unit 200.

The tuner 100 adjusts reception channels so that the broadcasting signals can be tuned to the channel requested by an input/output control unit 130, which is controlled by the main control unit 200.

The switching unit 120 is controlled by the input/output control unit 130, to selectively inter connect input and output terminals (not shown) connected with one or more external A/V input/output devices.

The A/V decoder 142 decodes the audio/video signals received through the switching unit 120 and outputs them to the MPEG encoder 146. The A/V decoder 142 is controlled by the main control unit 200.

The A/V encoder 144 encodes the data which is MPEG-decoded by the MPEG decoder 220 of the main control unit 200, and the audio/video signals which are decoded by the A/V decoder 142, and outputs the encoded signals to the switching unit 120.

The MPEG encoder 146 is controlled by the main control unit 200, to encode the audio/video signals output from the A/V decoder 142 in accordance with a predetermined compression format, and store the data to be recorded in a large-capacity storage device, i.e., in the HDD 400. Preferably, the motion picture data is encoded in accordance with MPEG-2 compression. Reference numeral 146a refers to a SDRAM employed as a memory for the encoding process which occurs in the MPEG encoder 146.

The data maintenance unit 148 performs maintenance on the reproducing and recording of the data with respect to the HDD 400 and/or DVD-ROM 300. In other words, the data maintenance unit 148 is controlled by the main control unit 200, to perform the maintenance of recording of the recorded data from the DVD-ROM 300 to the HDD 400, or recording of the recorded data from the HDD 400 to the DVD-ROM 300, or the recording of the encoded data from the MPEG encoder 146 to the HDD 400.

The key input unit 152 is provided as an interface, and comprises manipulation keys through which a user can select a command. Accordingly, the user manipulation signals selected through the key input unit 152 are output to the main control unit 200. The light receiving unit 154 is also provided as an interface, and receives user manipulation signals from external input devices such as remote controller and outputs the signals to the main control unit 200.

The main control unit 200 processes the user manipulation signals received through the key input unit 152 and the light receiving unit 154, and accordingly controls the respective parts. The main control unit 200 in this example is provided as a single chip type of IC, but can alternatively comprise multiple components, and contains the MPEG decoder 220 for decoding the compressed signal in MPEG format. Thus, the MPEG decoder 22 is combined with the central processing unit (CPU).

An operation program of the main control unit 200 is recorded in a flash memory 200a. The flash memory 200a is provided with a menu guide/process unit that processes to display a menu guide list on a screen. Reference numeral 200b refers to a SDRAM, which is used as a temporary recording space by the main control unit 200.

In operation, the main control unit 200 processes the operation of various functions (or features) in accordance with the commands received from the key input unit 152 and the light receiving unit 154, by loading the associated programs installed in the flash memory 200a.

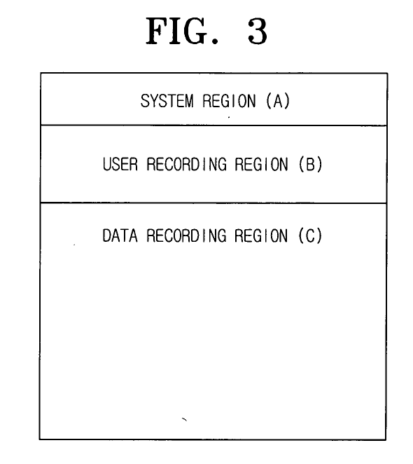

In accordance with an embodiment of the invention, the DVD-ROM 300 reproduces motion picture data from the optical disc recording medium. Under the control of the data maintenance unit 148, the HDD 400 records the motion picture data output from the MPEG-encoder 146 and the DVD-ROM 300, and reproduces the recorded motion picture data. The recording space of the HDD 400 is provided with a data recording region (region C; see FIG. 3) and a user recording region (region B; see FIG. 3). The data recording region is where the motion picture data is recorded, and the user recording region is where the additional information, which is edited by the user with respect to the motion picture data, is recorded. For the purpose of the present description, the motion picture data will be described in the context of the MPEG-format, though, as one skilled in the art can appreciate, the invention is not limited to that or any particular data format.

Accordingly, in the process of recording the motion picture data in the data recording region, the HDD 400 records the additional information in the user recording region. The additional information includes recording location information, which is edited with respect to the motion picture being recorded in the data recording region. It is preferred that the backup data corresponding to the additional information also be recorded together with the additional information being recorded in the user recording region. The HDD 400 can additionally record the error check information in the user recording region with respect to the additional information, and the backup data for the purpose of an error check, during a recording of the motion picture data in the data recording region by the HDD 400.

Meanwhile, the DVD/HDD image recording/reproducing apparatus according to an embodiment of the invention is provided with an abnormal operation detecting unit 160 that detects whether the system operates abnormally or not. Accordingly, if, during a recording of the motion picture data in the data recording region (B) of the HDD 400, the abnormal operation detecting unit 160 detects an error occurrence with respect to the recording operation, it will transmit the detected result to the main control unit 200.

When the main control unit 200 determines from the detection information transmitted by the abnormal operation detecting unit 160, that there is an abnormal operation of the HDD 400, the main control unit 200 issues a command to the power supply unit 520. The power supply unit 520 supplies power to the DVD/HDD image recording/reproducing apparatus. In this instance, the command controls the reset unit 540 to re-start the DVD/HDD image recording/reproducing apparatus having the DVD-ROM 300 and the HDD 400 therein. In accordance with the system re-start command from the main control unit 200, the reset unit 540 controls the power supply unit 520 to cut off, and then re-supply the power.

With the re-starting of the DVD/HDD image recording/reproducing apparatus by the power supply unit 520, the main control unit 200 determines, based on the additional information stored in the user recording region (B) of the HDD 400, the error generating location of the data recording region (C), where the error is generated in the motion picture data recording. Accordingly, the main control unit 200 controls the HDD 400 to delete the motion picture data that is recorded after the error occurrence in the data recording region. Further, the main control unit 200 controls the HDD 400 so that the motion picture data recorded after the error occurrence can be deleted, while the additional information and the backup data of the additional information corresponding to the remaining motion picture data in the data recording region can be updated in the user recording region.

In accordance to with an embodiment of the invention, the abnormal operation detecting unit 160 determines the presence of damage of the backup data of the pre-recorded additional information, prior to the recording of the additional information of the motion picture data in accordance with the recording operation, and recording of the backup data corresponding to the recorded additional information in the user recording region. The main control unit 200, determining the backup data of the pre-recorded additional information to be damaged, controls the reset unit 540 to thereby control the power supply unit 520 to re-drive the DVD/HDD image recording/reproducing apparatus.

As the DVD/HDD image recording/reproducing apparatus is re-driven, the main control unit 200 performs controlling on the operation of the hard disc drive 400 with the power which is re-supplied in response to the abnormal operation.

Preferably, when the DVD/HDD image recording/reproducing apparatus is re-booted with the HDD 400 having already recorded the additional information of the motion picture data and the backup data corresponding to the additional information in the user recording region, the abnormal operation detecting unit 160 determines whether the additional information recorded in the user recording region (B) of the HDD 400 is damaged or not. When the additional information is determined to be damaged, the main control unit 200 recovers the damaged additional information based on the corresponding backup data. Accordingly, the HDD 400 can delete the motion picture data that is erroneously recorded due to abnormal operation, recover the motion picture data recorded before the abnormal operation, and update the additional information of the recovered motion picture data and the backup data of the additional information.

Meanwhile, with the additional provision of the error check information corresponding to the additional information and the backup data in a predetermined recording space, the abnormal operation detecting unit 160 can determine whether the pre-recorded additional information and the corresponding backup data is damaged or not, based on the error check information. Prior to the updating of the backup data corresponding to the prerecorded additional information, it is preferred that the abnormal operation detecting unit 160 determine an error occurrence based on the error check information which is recorded with respect to, and together with, the prerecorded backup data.

By recording the additional information edited for the motion picture data and also the backup data corresponding to the additional information together with the motion picture data being recorded in the HDD 400, and then re-driving the system in the event of error occurrence in the HDD 400 and recovering the damaged motion picture data based on such recorded additional information and the backup data, motion picture data can be stably recovered even when the recording error occurs.

FIG. 3 shows the recording space of the HDD 400 being divided into sub-recording regions by way of one example. Referring to FIG. 3, the recording space of the HDD 400 can be divided into a system region A, a user recording region B and a data recording region C.

The system region A is where the driving programs in association with the operation of the main control unit 200 of the DVD/HDD system are stored. The user recording region B is where the additional information with respect to the motion picture data and the backup data corresponding to the additional information are recorded. The user recording region B also contains the error check information with respect to the additional information and the backup data. The data recording region C is where various data, including the motion picture data from the tuner 110, the switching unit 120 and the DVD-ROM 300, is recorded.

According to an embodiment of the present invention, the additional information edited by the user with respect to the motion picture data and the backup data corresponding to the additional information are recorded in the user recording region B together with the motion picture data which is recorded in the data recording region C. Further, the user recording region is additionally recorded with the error check information for the additional information and the backup data.

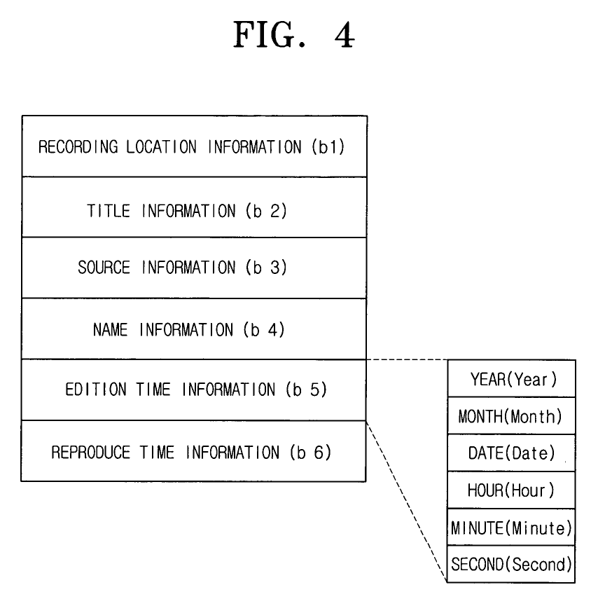

FIG. 4 is a view showing the additional information of the motion picture data being recorded in the user recording region B.

As shown, the additional information includes recording location information b1, title information b2, source information b3, name information b4, edition time information b5 and reproduce time information b6 of the motion picture data. The edition time information b5 includes information such as year, month, date, hour, minute and second of motion picture data recording and editing. Accordingly, the additional information and the backup data corresponding to the additional information is recorded in the user recording region B.

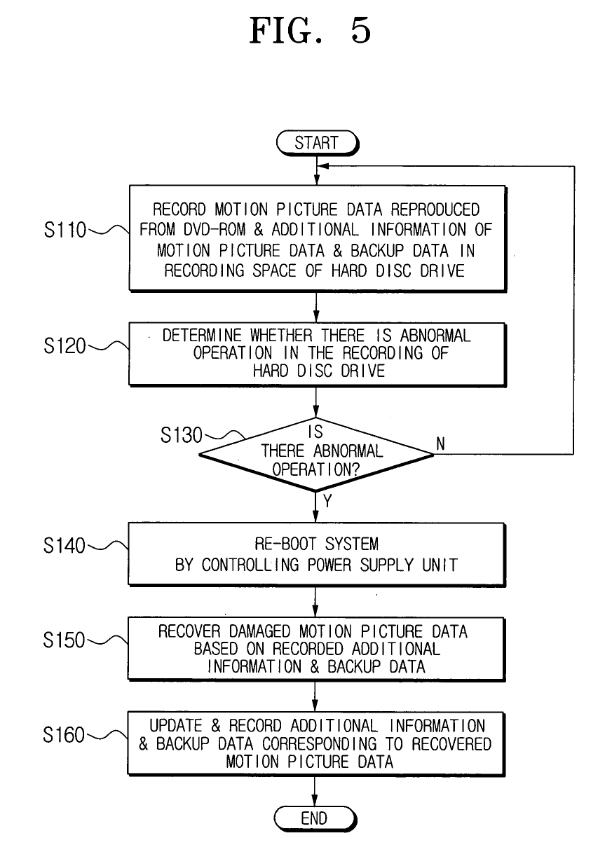

FIG. 5 is a flowchart showing a method of recovering image data in the event of error occurrence in the DVD/HDD image recording/reproducing apparatus according to an embodiment of the present invention.

First, in accordance with the controlling by the main control unit 200 of the HDD 400, the motion picture data reproduced from the DVD-ROM 300, and the additional information and the backup data corresponding to the additional information are recorded in the appropriate recording space (step S10). At this time, the motion picture data is recorded in the data recording region (C) of the recording space, while the additional information and the backup data are recorded in the user recording region (B). The HDD 400 also records the error check information for the additional information and the backup data (in the user recording region B).

While the HDD 400 records the motion picture data, the additional information and the backup data, the abnormal operation detecting unit 160 determines whether there is an abnormality in the recording operation of the HDD 400 (step S120). When it is determined that there is no abnormal operation (“No” path from decision step S130), the HDD 400 reverts back to step S110.

When it is determined that there is an abnormal operation in S130 (“Yes” path from decision step S130), the main control unit 200 controls the power supply of the power supply unit 520 to control the reset unit 540 to cut off the power supply to the system, and then re-supply the power to re-boot the system (step S140).

As the DVD/HDD image recording/reproducing apparatus is re-booted according to the re-supply of power from the power supply unit 520, the main control unit 200 recovers the damaged motion picture data based on the additional information and the backup data corresponding to the additional information recorded in the recording space of the HDD 400 (step S150). The motion picture data recovery by the main control unit 200 includes a recognition of recording location of the motion picture data based on the additional information and the backup data, and deletion of the motion picture data which is recorded after the damage occurs.

Further, the main control unit 200 controls the HDD 400 to update the additional information corresponding to the motion picture data and the backup data and record the updated data in the HDD 400 (step S160).

In the event of error occurrence during the recording of the motion picture data with respect to the HDD 400, the system is re-booted, and the motion picture data having an error is deleted based on the additional information and the backup data as recorded. Then, by recovering the motion picture data that has no error and updating the additional information for the motion picture data as recovered, damage to the entire motion picture data due to abnormal operation of the HDD 400 can be prevented.

According to the DVD/HDD image recording/reproducing apparatus of an embodiment of the present invention, the motion picture data is recorded together with the additional information and the backup data corresponding thereto. Accordingly, in the event of error occurrence during a recording, the system is re-booted, and the error-containing motion picture data is deleted based on the additional information and the backup data, as recorded during the recording. Then, the remaining motion picture data is recovered and the additional information and the backup data are updated for the motion picture data as recovered. As a result, even when error occurs during the recording of the motion picture data, the motion picture data that contains no error can be safely recovered.

Although a few preferred embodiments of the present invention have been described, it will be understood by those skilled in the art that the present invention should not be limited to the described preferred embodiments, but various changes and modifications can be made within the spirit and scope of the present invention as defined by the appended claims.

What is claimed is:

1. A method for recovering motion picture data in the event of a recording error, comprising:
reproducing image data stored in a first storage device;
recording image data, additional information and back-up data in a second storage device;
determining that the image data contains an error as it is stored on the second storage device; and
recovering error free image data from the additional information and the back-up data that corresponds to the image data containing the error.

2. The method according to claim 1, further comprising:
deleting the image data that contains the error; and
recording in the second storage device the recovered error free image data in an appropriate location.

3. The method according to claim 1, wherein the first storage device includes a DVD-ROM.

4. The method according to claim 1, wherein the second storage device includes a HDD.

5. The method according to claim 1, wherein the step of determining that the image data contains an error as it is stored on the second storage device is performed by an abnormal operation detection unit.

6. The method according to claim 1, further comprising the step of rebooting the power supply comprises when the determining step determines that the image data contains an error.

7. The method according to claim 6, wherein the rebooting step comprises:
issuing a command from a main control unit to a power supply control unit; and
issuing a command from a power supply control unit to a power supply, to momentarily turn the power supply off and then on.

8. The method according to claim 1, wherein the step of recording image data, additional information and back-up data in a second storage device (HDD) comprises:
storing image data in a data recording region of the HDD; and
storing additional information, back-up data and error check information in a user recording region of the HDD.

9. The method according to claim 1, wherein the step of determining that the image data contains an error as it is stored on the second storage device comprises:
checking image data as it is stored on the second storage device; and
transmitting a detected result indicating an error occurrence to a main control unit.

10. The method according to claim 1, wherein the image data is motion picture data.

11. The method according to claim 10, wherein the motion picture data is stored in a known file format.

12. the method according to claim 11, wherein the known file format is MPEG-2.

13. An image recording/reproducing apparatus for recovering image data in the event of a recording error, comprising:
a first storage device for reproducing image data from a recording medium;
a second storage device for recording the image data in a data recording region, and recording additional information containing a recording location information of the image data and backup data for the additional information in a user recording region;
an abnormal operation detecting unit for determining whether an error occurs in the recording of the image data is being recorded in the data recording region of the second device;
a reset unit for re-driving the first and the second devices, when an error occurs, and
a control unit for determining an error occurring location of the image data recorded in the data recording region based on the additional information recorded in the user recording region of the re-driven second device and for recovering error free image data from the additional information and the backup data that corresponds to the image data containing the error.

14. The apparatus according to claim 13, wherein the first storage device is a DVD-ROM.

15. The apparatus according to claim 13, wherein the second storage device is a HDD.

16. The apparatus according to claim 13, wherein the first storage device is divided into a data recording region and a user recording region.

17. The apparatus according to claim 13, further comprising:
a power supply for receiving a command from the reset unit causing the power supply to momentarily turn on and off.
